(19) United States
(12) Patent Application Publication
(10) Pub. No.: US 2007/0150379 A1
(43) Pub. Date: Jun. 28, 2007

(54) Method and system for real-time monitoring of part availability

(76) Inventors: Kathryn R. Vernaci, Rochester Hills, MI (US); Steven M. Kurtycz, Shelby Township, MI (US); David M. Koski, Chesterfield, MI (US); Bruce A. Mitchell, Macomb, MI (US); Renee M. Silverman, West Bloomfield, MI (US); Stephen J. Francis, Rochester Hills, MI (US); Annamalai Kailainathan, Troy, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/292,464

(22) Filed: Dec. 2, 2005

(51) Int. Cl. G06Q 10/00

(52) U.S. Cl. 705/28

(57) ABSTRACT

A method and system for real-time monitoring of part availability uses a computer-based data integration system communicating with at least one plant related database and at least one supplier related database to collect part usage and shipment data and to assess the collected data to predict an exception to a scheduled part need time. When an exception is predicted, the data integration system generates an alert indication to personnel for taking corrective action.

### FIELD

The invention relates generally to real-time assessment of part availability at a manufacturing or assembly plant. More specifically, the invention concerns real-time monitoring of potential parts shortages and alert generation regarding required changes to part need times.

### BACKGROUND

Conventional approaches to predicting part shortages at a plant do not run in real time, do not use dynamic data and only use plant records involving part inventory, usage and shipping schedules. Hence, there is a need in the art for a data integration and assessment system that runs in real time and collects data from a variety of plant and supplier databases.

### SUMMARY OF INVENTION

A system for real-time monitoring of part availability includes at least one plant related database containing data relating to usage and inventory of the part, and at least one supplier related database containing data relating to shipment of the part. A computer based data integration system is in communication with the at least one plant related database and the at least one supplier related database. The data integration system is operative to examine in real time data in the at least one plant related database and data in the at least one supplier related database to assess the examined data to predict an exception to a scheduled part need time. The integration system then generates an alert indication to personnel whenever an exception is predicted.

In another aspect of the invention, a method for real-time monitoring of part availability collects real-time data from at least one plant related database concerning usage and inventory of the part, collects real-time data from at least one supplier related database concerning shipment of the part, and assesses the collected data to predict an exception to a scheduled part need time. The method then generates an alert indication to personnel whenever an exception is predicted.

### BRIEF DESCRIPTION OF THE DRAWING

The objects and features of the invention will become apparent from a reading of a detailed description, taken in conjunction with the drawing, in which:

FIG. 1 is a block diagram setting forth a data integration system in communication with a variety of databases in accordance with the principles of the invention;

FIG. 2 is a timing diagram of shipping and delivery information in which no exceptions are present;

FIG. 3 is a timing diagram of shipping and delivery information in which a shortage exception is predicted; and

FIG. 4 is a flow chart setting forth an example of a method performed by the data integration system of the invention to predict a part availability exception.

### DETAILED DESCRIPTION

The following description is merely exemplary in nature and is in no way intended to limit the invention, its application or scope.

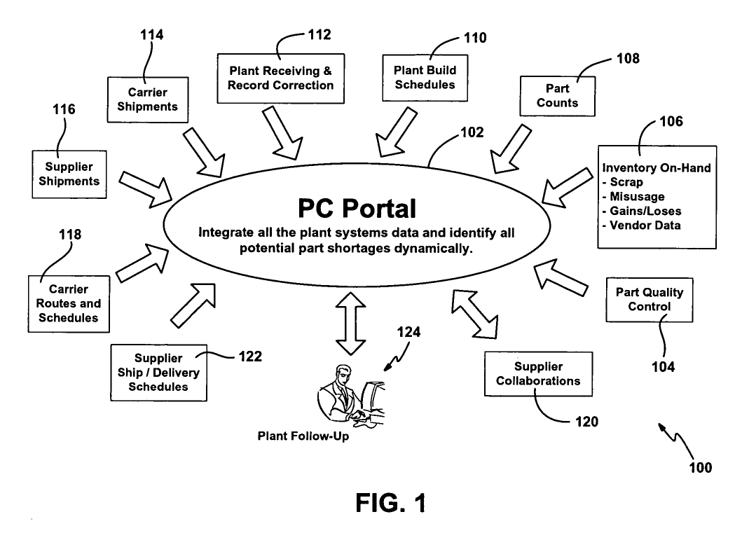

Referring to FIG. 1, PC Portal 102 is a computerized data integration and assessment system for integrating plant systems data and supplier systems data for predicting part shortages or part surpluses in a manufacturing or assembly plant environment. System 102 integrates all the plant systems data and identifies all potential part shortages and part surpluses dynamically.

As further seen from FIG. 1, PC Portal or data integration system 102 is in data communication with a variety of plant related and supplier related databases. Specifically, in the example of FIG. 1 data integration system 102 is in communication with regional plant system databases such as part quality control 104, inventory stock status 106, physical part counts data 108, plant build or usage scheduled data 110, and plant receiving and record correction data 112.

Additionally, data integration system 102 is in data communication with various carrier databases such as carrier shipment database 114, carrier route and scheduling database 118 and supplier collaboration database 120. Other databases which may be examined by system 102 are supplier shipment database 116, supplier ship and delivery scheduling database 122 and a plant follow-up computer 124.

The key factors considered by system 102 of FIG. 1 are part need time at the plant and part delivery at the plant. System 102 is operative to predict exceptions to scheduled need times and deliveries as a function of inventory and part usage at a particular plant. System 102 continuously evaluates the scheduled, projected, expected or actual delivery is respectively compared to the scheduled, projected, expected or actual need time. If any of the examined delivery data shows that delivery will occur after a given need time, an exception is triggered and an alert indication is generated by system 102. Any event that affects either part need time or part delivery would trigger an exception identification process. Such events include changes to production schedules, changes to shipment schedules, advance shipment consolidation, advance shipment notification, estimated time of arrival updates from carriers, inventory adjustments, trailer arrival at the delivery yard, receiving schedules for trailers at loading docks, discrepancy in receiving and defective material notifications.

Data integration system 102 performs calculations which result in alerts to be acted upon. System 102 presents the expected shortage time (run out) and all relevant supply chain data to analyze the problem. Using this information, analysts at plant follow up computer center 124 determine if the alert is genuine.

Data elements included to fully analyze a potential part shortage or part surplus, include, but are not limited to the following:

Real-time inventory records.
Physical inventory counts.
Real-time inventory adjustment data.
Forecasted part usage.
Actual part usage.
Real-time shipping date including estimated time of arrivals.
Shipping route data (transit hours, shipping locations along route, etc.).
Past and future shipping schedules.
Real-time supplier shipping status (ahead of schedule or behind schedule).

System 102 incorporates two-way communication with the supplier at database 120 to request additional shipments. Suppliers can respond with a future promise to ship which includes quantity, transportation mode and future shipping time.

System 102 of FIG. 1 utilizes planned and actual supply chain events and part usage events to assess collected data for exceptions to planned need times for the parts in question. The assessment is performed during an adjusted cut-off period which is calculated as the current time plus rounded up transit time of the part being shipped plus one day, or 24 hours. This is known as the adjusted rolling cut-off period (ARCP).

A potential shortage calculation at system 102 uses planned supply chain events until such time that actual supply chain events occur. Once an actual event occurs, the shipping and delivery time line plan is reevaluated with the actual event or events taken into account. The potential shortage calculation will continue using either planned or actual events through the adjusted rolling cut-off period. If at any time during the calculation period a projected on-hand amount of parts goes below zero without either a planned or actual shipment arriving prior to zero time, an exception, e.g., a potential shortage, will be identified.

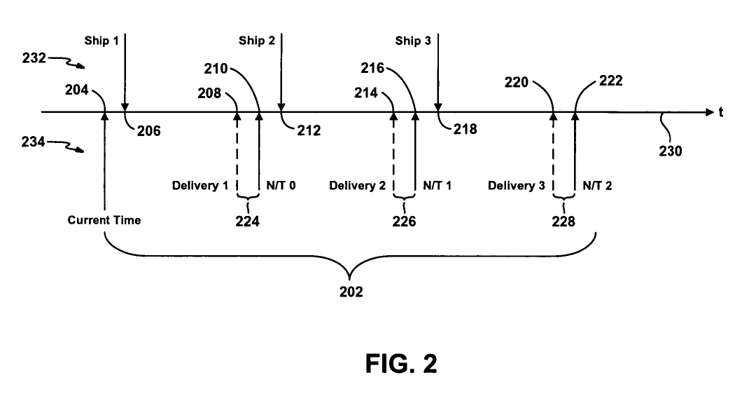

FIG. 2 presents a time line 230 showing pertinent shipping information 232 above the time line 230 and pertinent delivery information 234 below the time line 230 and both shipping and deliveries being monitored over an adjusted rolling cut-off period 202.

Scheduled future shipments 206, 212 and 218 are shown relative to scheduled future delivery times 208, 214 and 220. Need time 0 at 210 is based on the part quantity on hand and the projected usage of the part at the present time. Need time 1 of that part at 216 is based on the scheduled part quantity in Delivery 1 at time 208 and the projected usage at the present time. Need time 2 at time 222 of the part is based on the scheduled part quantity in Delivery 2 at 214 and projected usage. In the example shown in FIG. 2, there are no exceptions, because all scheduled deliveries are shown occurring prior to the related need time. At each Delivery 1, 2 and 3, there is shown a safety float time 224 for Delivery 1, 226 for Delivery 2 and 228 for Delivery 3. In the perfect scenario where no exceptions occur, the part should be delivered exactly when needed at the plant. However, to account for any unplanned events that could affect the production or assembly line, there is a safety stock, i.e., a float, available to be consumed at any time. With the safety stock in mind, when the material is delivered, there should not be material or parts in excess of the predetermined safety stock. There are many factors that lead to having parts in the saturated float status at the plant. System 102 of FIG. 1 can identify the projected or actual material available at the time of delivery in excess of the required safety stock and notify appropriate personnel at station 124 for corrective actions.

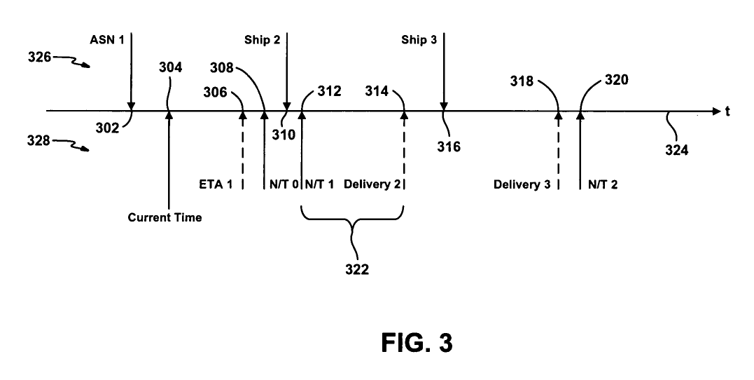

FIG. 3 sets forth the time line shipping and delivery information for the situation in which an exception state or shortage is identified. Shipping information 326 again is above time line 324 while delivery information 328 is set forth below time line 324. In the example of FIG. 3, note that Delivery 2 at time 314 has been assessed to be occurring later than the need time associated therewith at 312, thus presenting the shortage period 322. In this example, the supplier has short shipped, and as a result Need Time 1 at 312 shifts backwards along time line 324 to occur prior to the scheduled second delivery at time 314. This new need time at 312 is calculated using parts on hand and scheduled production or usage of the part. System 102 identifies exception 322 and alerts personnel at station 124 that a shortage will occur and how much of a shortage there will be as a result of the planned usage data for the part and the current amount on hand.

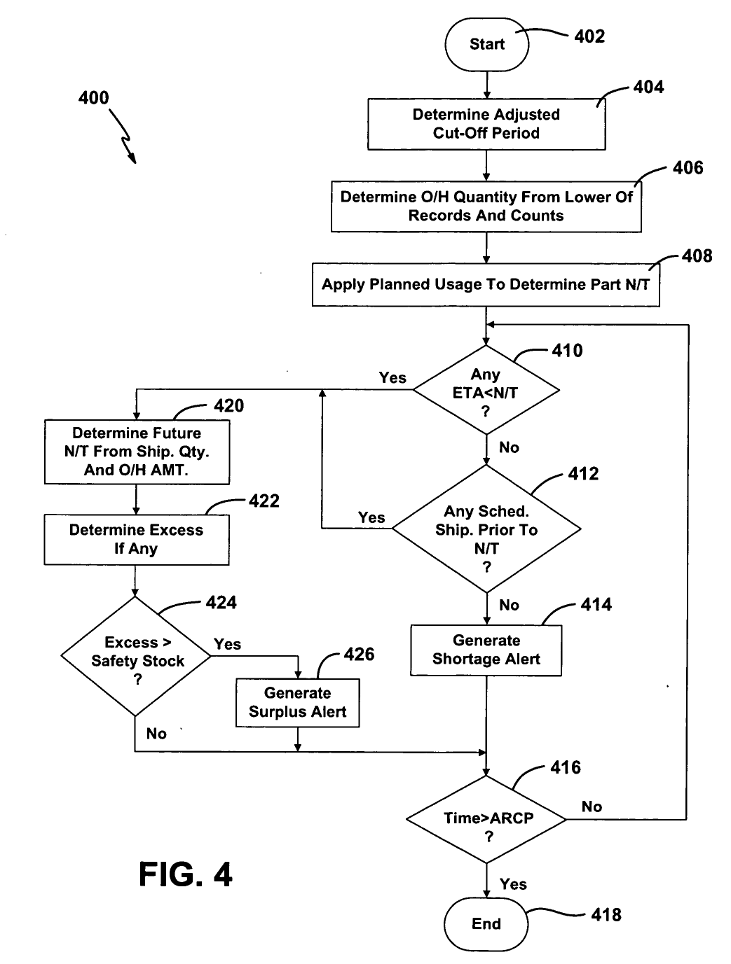

FIG. 4 sets forth a flow chart demonstrating an exemplary method performed by data integration system 102 of FIG. 1 in generating either shortage alerts or excess or surplus alerts.

The method starts at 402 and proceeds to block 404 where the adjusted cut-off period (ARCP) is determined. Next, at block 406 the on-hand quantity of the part in question is determined from the lower of the electronic records in the plant related databases and records of physical counts in such databases.

At step 408, system 102 applies planned usage data to determine the next need time for a part.

At decision block 410, system 102 determines whether there are any estimated time of arrivals for delivery of the parts occurring before an associated need time. If not, the system then determines at decision block 412 whether any scheduled shipments are planned prior to the pertinent need time. Again, if the answer is no, then at 414 the system generates a shortage alert, checks to see whether the ARCP has been exceeded at decision block 416 and if it has, ends the routine. If ARCP has not been exceeded, then the routine returns to decision block 410.

If at decision block 410 any estimated time of arrival is occurring prior to a need time, then a future need time is determined from the shipment quantity and the on-hand amount of the part at step 420. At block 422, any excess of parts is determined. At decision block 424, the excess is compared to a predetermined safety stock level, and if the excess exceeds the safety stock, then at 426 a surplus alert is generated by the system for use by appropriate plant personnel. If the excess does not exceed the safety stock, then the routine proceeds to decision block 416 where it is again checked to see whether the ARCP has been exceeded.

The foregoing detailed description has been presented only for the sake of example. The scope and spirit of the invention are to be determined from appropriate interpretation of the appended claims.

What is claimed is:

1. A system for real-time monitoring of parts availability comprising:
at least one plant related database containing data relating to usage and inventory of the part;
at least one supplier related database containing data relating to shipment of the part; and
a computer-based data integration system in communication with the at least one plant related database and the at least one supplier related database, the data integration system operative to examine in real time data in the at least one plant related database and data in the at least one supplier related database to assess the examined data to predict an exception to a scheduled part need time, and to generate an alert indication to personnel whenever an exception is predicted.

2. The system of claim 1 wherein the data integration system is further operative to determine that the exception is one of a shortage of the part and a surplus of the part.

3. The system of claim 1 wherein the data integration system is further operative to determine a degree of the exception.

4. The system of claim 2 wherein the data integration system is further operative to determine the degree of the shortage or the degree of the surplus.

5. The system of claim 1 wherein the data integration system is further operative to predict a shortage of the part, the amount of shortage and a required need time adjustment to prevent occurrence of the shortage.

6. The system of claim 1 wherein the data integration system is further operative to predict a surplus of the part, the amount of surplus, and determine whether the surplus exceeds a safe minimum stock of the part.

7. The system of claim 1 wherein the at least one plant selected database contains real-time inventory records, physical inventory counts, real-time inventory adjustment data, forecasted part usage data and actual part usage data.

8. The system of claim 1 wherein the at least one supplier related database contains real-time shipment data including estimated time of part arrival, shipping route data, past and future shipping schedules and real-time supplier shipping status.

9. The system of claim 7 wherein the at least one supplier related database contains real-time shipment data including estimated time of part arrival, shipping route data, past and future shipping schedules and real-time supplier shipping status.

10. The system of claim 1 wherein the data integration system assesses the examined data for a predetermined cut-off period for the part.

11. A method for real-time monitoring of part availability comprising:
collecting real-time data from at least one plant related database concerning usage and inventory of the part;
collecting real-time data from at least one supplier related database concerning shipment of the part;
assessing the collected data to predict an exception to a scheduled part need time; and
generating an alert indication to personnel whenever an exception is predicted.

12. The method of claim 11 further comprising determining that the exception is one of a shortage of the part and a surplus of the part.

13. The method of claim 11 further comprising determining a degree of the exception.

14. The method of claim 12 further comprising determining a degree of the exception.

15. The method of claim 11 further comprising predicting a part shortage and an amount of the shortage, and calculating a part need time adjustment to prevent occurrence of the shortage.

16. The method of claim 11 further comprising predicting a surplus of the part and the amount of the surplus, in determining whether the surplus exceeds a safe minimum stock of the part.

17. The method of claim 11 wherein real-time data collected from the at least one plant related database contains inventory records, physical inventory counts, inventory adjustment data, forecasted part usage data and actual part usage data.

18. The method of claim 11 wherein real-time data collected from the at least one supplier related database contains estimated time of part arrival, shipping route data, past and future shipping schedules and supplier shipping status.

19. The method of claim 17 wherein real-time data collected from the at least one supplier related database contains estimated time of part arrival, shipping route data, past and future shipping schedules and supplier shipping status.

20. The method of claim 11 further comprising assessing the collected data for a predetermined cut-off period for the part.
